(19) United States
(12) Patent Application Publication
(10) Pub. No.: US 2011/0166968 A1
(43) Pub. Date: Jul. 7, 2011

(54) SYSTEM AND METHOD FOR ACTIVATING DISPLAY DEVICE FEATURE

(76) Inventors: Richard Yin-Ching Houng, Irvine, CA (US); Douglas Q. Woo, Hermosa Beach, CA (US); John Araki, Tustin, CA (US); Kenneth Randall, Anaheim, CA (US)

(21) Appl. No.: 12/816,553

(22) Filed: Jun. 16, 2010

Related U.S. Application Data
(60) Provisional application No. 61/292,573, filed on Jan. 6, 2010.

(51) Int. Cl. H04N 7/16; G06Q 30/00

(52) U.S. Cl. 705/30; 725/30

(57) ABSTRACT

A display device is initially provided with a deactivated feature that may be selectively activated as needed by an end user, with notification of the activation provided to an activation service. The activation service may provide an activation code or other activation either to the display device directly, or alternatively to the end user, for use in the activation process to activate the initially-deactivated feature. As another alternative the activation service may receive notification after the activation, or during the activation process, without necessarily providing any activation code or other key. The activation service may make use of the activation notification, such as for marketing purposes of determination of licensing fees due in connection with the initially-deactivated feature. The registration code may be used to create an activation code used for activating the initially-deactivated feature.

This application claims the benefit under 35 USC 119 to U.S. Provisional Application No. 61/292,573, filed Jan. 6, 2010, which is incorporated by reference in its entirety.

### BACKGROUND OF THE INVENTION

1. Field of the Invention

The invention is in the general field of systems and methods for activating features of display devices.

2. Description of the Related Art

Product activation is well known to protect software products. Product activation is a license validation procedure required by some computer software programs. Product activation is used to invalidate or severely restrict a product's functionality until the product is registered with a publisher by means of a special identification (activation) code or “product key.” Product activation often refers to a method where a software application or suite hashes hardware serial numbers and an identification (ID) number specific to the product's license (e.g., the product key) to generate a unique installation ID. The installation ID is sent to the manufacturer to verify the authenticity of the product key and determine that the product key is not being used for multiple installations. Other product key models are also used to enforce the purchase of a license for use of the software product.

Products may also have various activation states. An “un-activated” product usually acts as a time-limited trial until a product key is purchased. An “activated” product has its product key purchased and entered. Some products allow licenses to be transferred from one machine to another without deactivating the copy on the old machine before reactivating the software product on the new machine.

Many software licensing systems provide a different license depending on the type of product being sold. For example, the license that accompanies a trial product is usually more limited in its scope than the license of a full or “perpetual” product.

It will be appreciated that licensing and activation methods for software products address needs in only one narrow product type.

### SUMMARY OF THE INVENTION

The present invention involves product activation and registration of a hardware product or device. It is known to register a device for the purpose of tracking the play of media on the device (for example the DivX Video On Demand program involves registration of DivX-certified devices, such as televisions). However, registration of digital displays, such as digital televisions (DTVs) in the present invention is not for the purpose of protecting media played on the DTV. The purpose of the present invention is to ensure appropriate protection of intellectual property rights that pertain to some modes of operation of the device (digital televisions), but that do not pertain to other modes of operation.

In many software or device product activation programs in which the product is shipped to the consumer or purchased by the consumer in a bricks-and-mortar store, the product's registration or activation code comes with the device or software. For example in the DivX registration program, for some device manufacturers the activation code can be found by searching through the device's on-screen menus with the remote control. Some manufacturers also include the DivX VOD registration code in the manual for the device. However in the present invention, the activation code does not come with the digital television (or other display device) for reasons explained below.

An important component for certain modes of operation of digital televisions is the tuner, which converts an RF television transmission into audio and video signals that can be further processed to produce sound and a picture. The present digital television tuner activation process requires the DTV user to obtain an activation code from the manufacturer or (preferably) a secure third party registry, referred to herein as an activation service. In addition, the activation process also registers the activation transaction to protect rights holders affected by the transaction. In view of this function, the activation service is sometimes referred to herein as a registration service. For example a consortium of participating manufacturers might form a secure registry; or the manufacturers might retain a service provider such as VeriSign, Inc. which operates network infrastructure such as domain name root servers, and provides a variety of security and telecom services. The secure registry would securely provide activation codes to digital television (or other display device) owners, maintain a registry of manufacturers and product IDs for which tuners are presumed to have been activated, and issue reports to interested entities as described below.

Typically when a software or device user obtains an activation code in order to license software or a proprietary device, the user pays a fee to obtain the code. The preferred embodiment of the present invention employs a different arrangement in which license fees for DTV tuner activation are not paid by the consumer, but rather by the DTV (or other display device) manufacturer. The process for obtaining the activation code ensures that manufacturers are notified of their obligation to pay license fees. In addition, participating manufacturers can register license agreements with the activation/registration service. The activation/registration service can issue reports of DTV tuner activation transactions to participating manufacturers for inclusion in royalty reports, directly to licensors of registered license agreements, or both. Where additional information such as DTV size or net selling price would be needed for license reporting (such as information used in calculating royalty), the manufacturer can provide that information by maintaining data files that link a serial number or individualized product code to the additional information for each DTV.

According to an aspect of the invention, the DTV tuner activation may enable the DTV to receive and process digital programming sent over-the-air (sometimes called terrestrial broadcasting). In addition to or as an alternative to terrestrial broadcasting, the DTV tuner activation may enable the DTV to receive and process digital programming sent over coaxial cable by cable providers.

According to another aspect of the invention, contact with a registration service occurs as part of an activation process for activating a feature of a display device. The contact may be direct contact between the display device and the activation service, or may be contact using an end user of the display device as an intermediary.

According to another aspect of the invention, a manufacturer or other licensee only pays license fees for display devices that are indicated by an activation service as having had activated an initially-deactivated feature that is the subject of the license fees. For example, for DTVs operating under Advanced Television Systems Committee (“ATSC”) standards for digital television transmission, the license fees may pertain to patented aspects of the ATSC standards.

According to still another aspect of the invention, activation of an initially-deactivated feature of a display device includes communicating at least a registration code to an activation service.

According to another aspect of the invention, activation of an initially-deactivated feature of a display device includes receiving at least an activation code from an activation service.

According to a further aspect of the invention, a method of controlling display device configuration includes the steps of: providing a display device that includes an initially-deactivated feature; providing an end user of the display device with an opportunity to activate the initially-deactivated feature; and if the end user makes a decision to activate the feature, providing notification of the decision to activate to an activation service.

According to a still further aspect of the invention, a method of paying licensing or other fees for display devices includes the steps of: providing the display devices to end users, wherein the display devices each have an initially-deactivated feature; receiving from an activation service information on the number of activation transactions for the display devices; and paying the fees based on the number of the activation transactions. For fees that depend upon additional information about display devices such as such as DTV size or net selling price, the method for paying licensing or other fees may include the step of providing that additional information for each of the activation transactions.

According to another aspect of the invention, a method of controlling display device configuration includes the steps of: providing a display device that includes a feature in a first state; providing an end user of the display device with an opportunity to change functionality of the feature from a first state to a second state; and if the end user changes functionality of the feature, providing notification of the change of functionality to an activation service.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

Annexed are drawings depicting one or more embodiments of the invention. The drawings are not necessarily to scale.

FIG. 1 is a schematic view of an activation system and its operation, in accordance with an embodiment of the present invention.

FIG. 2A is a schematic view of a display device that is part of the activation system shown in FIG. 1.

FIG. 2B is a schematic view of an alternative configuration display usable with the system shown in FIG. 1.

FIG. 3 is a schematic view of a first mode of operation of an activation system in accordance with an embodiment of the present invention.

FIG. 4 is a high-level flow chart showing some steps in the operation of the activation system of FIG. 3.

FIG. 5 is a screen shot of a prompt screen used to prompt an end user to obtain an activation code, as part of the method of FIG. 4.

FIG. 6 is a screen shot showing one way of initiating the activation method of FIG. 4.

FIG. 7 is a screen shot showing an alternative way of initiating the activation method of FIG. 4.

FIGS. 8 and 9 are screen shots illustrating another alternative way of initiating the activation method of FIG. 4.

FIG. 10 is a screen shot of an activation code entry screen used as part of the method of FIG. 4.

FIG. 11 is a screen shot of a confirmation screen indicating that the activation process of FIG. 4 has been successfully accomplished.

FIG. 12 is a screen shot showing one way of informing an end user about a security or authentication code that may be required for activation.

FIG. 13 is a screen shot showing another way of informing an end user about a security or authentication code that may be required for activation.

FIG. 14 is a screen shot showing yet another way of informing an end user about a security or authentication code that may be required for activation.

FIG. 15 is a schematic view of a second mode of operation of an activation system in accordance with an embodiment of the present invention.

FIG. 16 is a schematic view of a third mode of operation of an activation system in accordance with an embodiment of the present invention.

FIG. 17 is a high-level flow chart showing steps of operation of the activation system mode of FIG. 16.

FIG. 18 is a schematic diagram of a system for activating a tuner of a display device, in accordance with an embodiment of the invention.

FIG. 19 is a screen shot of one possible prompt usable in the process of the system of FIG. 18.

FIG. 20 is a screen shot of one possible web page usable in the process of the system of FIG. 18.

FIG. 21 is a screen shot illustrating entry of an activation code as part of the process of the system of FIG. 18.

FIG. 22 is a flow chart of a method of a tuner setup method for a display device, as part of an embodiment of the present invention.

FIG. 23 is a screen shot illustrating a selector screen usable in the method of FIG. 22.

### DETAILED DESCRIPTION

A display device is provided to an end user with an initially-deactivated feature that may be selectively activated as needed by the end user, with notification provided to an activation service. The activation service may provide an activation code or other activation information either to the display device directly, or alternatively to the end user, for use in the activation process to activate the initially-deactivated feature. The end user may notify the activation service of a decision to activate the initially-deactivated feature, and subsequently the feature may be activated using the activation information. In this approach, the end user or the display device may or may not notify the activation service of the completed activation, but the activation service may presume activation based upon the end user's decision to activate and providing activation information. Alternatively the activation service may receive notification of the activation during or after the activation, without necessarily providing any activation code or other key. As used in the present patent application, the term “activation transaction” means either notification of the activation service of the activation during or after the activation, or notification of the activation service of an end user's decision to activate together with the activation service providing activation information to end user or directly to the display device.

The activation service may make use of the activation notification, such as for marketing purposes or for determination of licensing fees due in connection with activation of the initially-deactivated feature. The notification may contain additional information regarding the display device, such as a serial number, individualized product code, or other registration code associated with the display device. The registration code may be used to create an activation code used for activating the initially-deactivated feature.

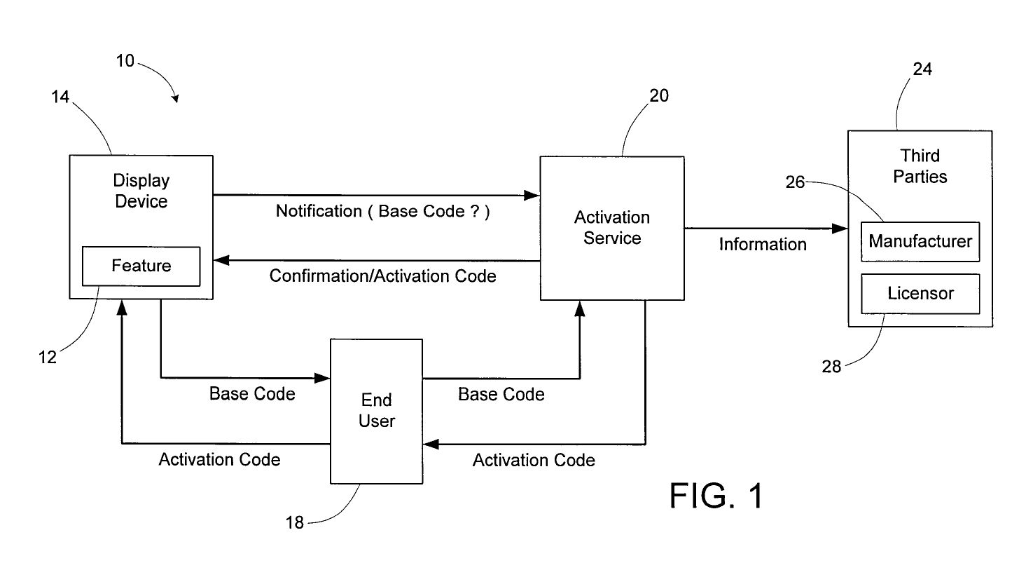

FIG. 1 conceptually illustrates feature activation system 10 for activating a initially-deactivated feature 12 of a display device 14. The display device 14 may be any of a variety of types of devices for displaying information, for example including televisions, digital televisions (DTVs), Internet protocol televisions (IPTVs), computer monitors or other monitors, large screen displays, movie theatre displays, projectors, and other means of creating video displays based upon video input sources. In addition, the display device 14 may alternatively include intermediate devices through which video signals pass, from a video source to an end device upon which the video is displayed. Thus references to methods that may be performed in conjunction with display devices may be considered to also be performable in such intermediate video devices. An example of such an intermediate device is a set top box, which received video from a source, such as a cable, antenna, or satellite, perhaps processes the input video signal, and outputs a video signal to a monitor, television, or other device for actually displaying video. Such intermediate devices may be referred to as video processing devices to distinguish them from display devices that actually display video. Intermediate video processing devices and display devices may be collectively referred to as “video devices” or “end user video devices.”

The individually-deactivated feature 12 broadly may be some sort of functionality of the display device 14, for instance functionality that is not necessary to some forms or configurations in which the display device 14 is operational. There may be a plurality of individually-deactivated features, and the display device may permit the end user to activate one or more, but not all, of these features.

The display device 14 may be configured to allow an end user 18 to activate the initially-deactivated feature 12 on the display device 14. The term end user is intended to be interpreted broadly to include not only a purchaser, consumer, or user (viewer) of the display device 14, but also someone acting on behalf of, under the direction of, or as an agent for such persons, including for instance technicians or installers, or those who configure the display device 14 subsequent to its manufacture, either before or after its acquisition by the ultimate owner. The activation process involves sending a notification of the activation or end user activation decision to an activation service 20. The notification may include a registration code and may be made as part of a process to obtain an activation code or key used to complete the activation process. Such an activation code or key may be provided to the end user 18, to be entered into the display device 14. Alternatively the activation code or key may be sent directly to the display device 14. Direct transmission of the activation code or key, or other activation signal, to the display device is particularly likely for “connected” display devices (such as IPTVs), i.e. for devices that are connected to a wired network, wireless network, or telecommunications network.

The notification to the activation service 20 may be simple notification of the fact of the activation, without the activation service 20 providing any activation code or device-specific information in return. The notification of the activation may include information for the individual display device 14, such as a serial number or other unique identifier (registration code) associated with the display device 14 having its feature being activated.

The activation service 20 may aggregate information about the number of activation transactions, as well as obtaining other information regarding the display devices 14 or regarding the features that have been or are to be activated. The information aggregated by the activation service 20 may be forwarded to one or more third parties 24. The third parties 24 may include the manufacturer or seller 26 of the display devices 14, and/or another party interested in activation of the initially-deactivated feature, such as a patent-holder or other licensor 28 due a royalty when the feature is activated. The activation service 20 may serve as a trust authority that services activation for multiple display device manufacturers and/or multiple intellectual property holders that would be due license or other fees upon activation. It will be appreciated that alternatively the activation service 20 may be a part of or owned at least in part by one or more of the third parties 24. The information forwarded to the third parties 24 may include the number of display devices 14 activated from each manufacturer. This could allow a determination to be made regarding royalty/licensing fees due, for example in reporting “unit royalty” licensing fees. Additional information about given display devices, such as DTV size, can be forwarded to the activation service by the manufacturer along with a unique identifier (serial number) for each of the given display devices. The activation service can correlate this additional information with display devices that have been activated using the serial numbers for those devices. This would allow a determination to be made regarding royalty/licensing fees due when that determination depends on the additional information.

Other information may be provided that may aid in learning about activities or uses of the display device 14 by the end user 18. Such other information may include the input to the display device (e.g. antenna or coaxial cable), other settings of the display device 14, the timing of activation relative to the time of purchase of the display device 14, and/or different activation patterns for different geographic locations and/or types of end users. This other information may be used for example by display device manufacturers, for example for marketing purposes, or by broadcasters such as to obtain more reliable information on the extent and geographic distribution of terrestrial broadcast reception.

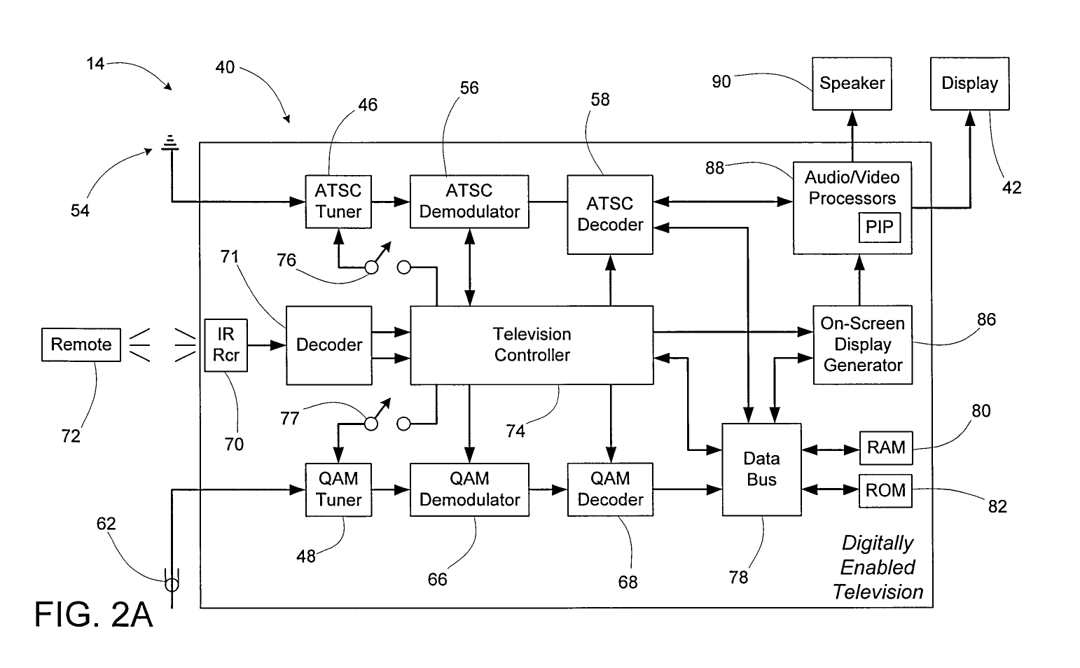

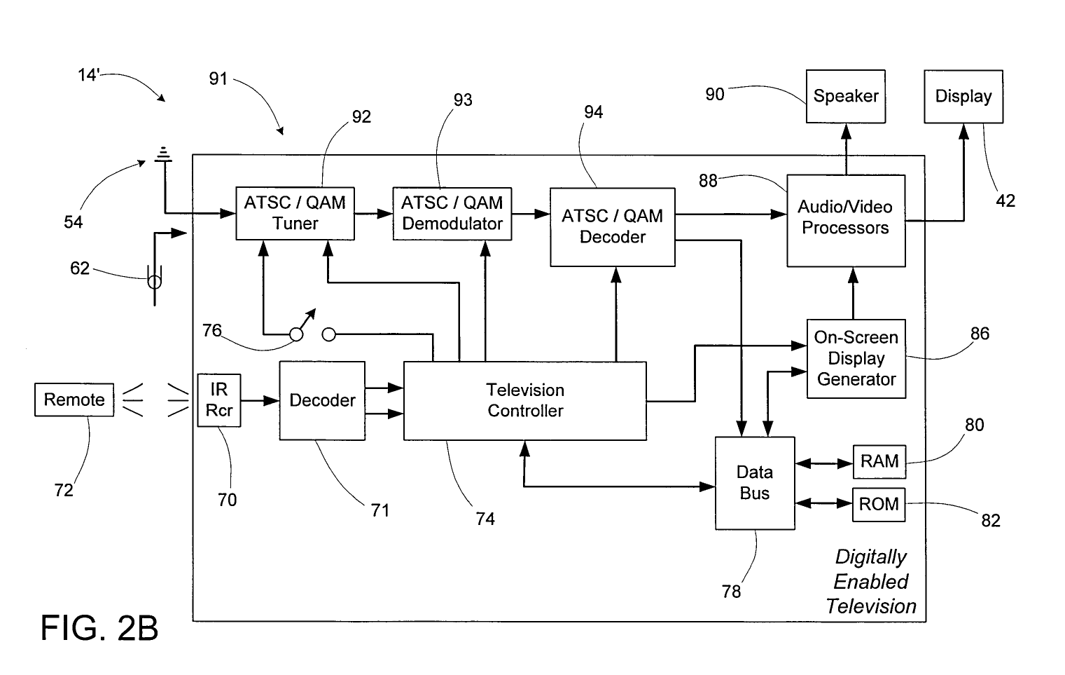

The initially-deactivated feature may include a tuner, or some functionality of a tuner, of the display device 14. With reference to FIG. 2A, the display device 14 includes an internal system 40 for processing and decoding incoming signals. The system 40 shown is a dual-tuner system for producing a picture-in-picture (PIP) on the display screen 42 of the display device 14. The ATSC tuner 46 and the QAM tuner 48 may be used to process different kinds of incoming signals. The ATSC tuner 46 may be used to process terrestrial broadcast signals. The terrestrial broadcast signals are represented in FIG. 2A as coming from an antenna 54. It will be appreciated that broadcast signals can be received from another source, such as from a cable company, sent through a coaxial cable 62 or other suitable medium that is directly coupled to the display device 14, to be processed by the QAM tuner 48 as noted below. Signals that pass through the ATSC tuner 46 are processed by an ATSC demodulator 56 and an ATSC decoder 58. On the other hand, when the ATSC tuner 46 is deactivated the ATSC demodulator 56 and ATSC decoder 58 do not receive or process any signals.

The QAM tuner 48 is a device present in some digital televisions and similar display devices that enables direct reception of digital cable channels from a cable company or other provider without the use of a set-top box. QAM stands for quadrature amplitude modulation, the format used by cable television providers to encode and transmit digital cable channels. The QAM tuner 48 is shown in FIG. 2A as being coupled directly to a coaxial cable 62. Signals received from coaxial cable 62 pass through the QAM tuner 48 and are processed by a QAM demodulator 66 and a QAM decoder 68.

Other parts of the system 40 include an infrared (IR) receiver 70 and a decoder 71 for receiving and decoding signals from an IR remote 72; a television controller 74 for coordinating operation of the various components of the system 40; a data bus 78 that is coupled to a RAM memory device 80 and a ROM memory device 82, as well as to other parts of the system 40; and an on-screen display generator 86 that is coupled to audio/video processors 88 for producing the picture and sound for the display system 14. The picture is displayed on the display screen 42, and the sound is played through a speaker 90. It will be appreciated that the configuration shown in FIG. 2A is only an example, and that many alternative configurations are possible.

FIG. 2B illustrates a system 91 of a display system 14′ incorporating a single, dual function tuner 92, combining both an Advanced Television Systems Committee (ATSC) standards tuner and a quadrature amplitude modulation (QAM) tuner, to produce a single picture on the display screen 42. The tuner 92, a demodulator module 93, and a decoder module 94 operate either in ATSC or QAM mode, depending on an RF input mode controlled by the television controller 74. An RF input port of the tuner 92 is capable of receiving and processing both terrestrial broadcast signals from the antenna 54 and cable broadcast signals from the coaxial cable 62. In FIG. 2B the antenna 54 is shown connected to tuner 91. Depending on the RF input mode controlled by controller 74, the tuner's output signal is processed by either by ATSC modulation and ATSC decoding, or by QAM modulation and QAM decoding. On the other hand, when both the ATSC and QAM modes of tuner 92 are deactivated, the ATSC/QAM demodulator module 93 and ATSC/QAM decoder module 94 do not receive or process any signals. Other aspects of the system 91 may be similar to those of the system 40 (FIG. 2A).

In the initially-deactivated mode of dual-tuner display device 14 (FIG. 2A) in which both the ATSC tuner 46 and the QAM tuner 48 are inoperable, the display device depends upon a set top box or other stand-alone receiving system to receive broadcast television signals (such as cable broadcasting or satellite broadcasting signals) and to process the received broadcast signals. Similarly, in the single tuner system 91 of FIG. 2B when both the ATSC and QAM modes of the tuner 92 are inoperable, the system 91 depends upon a stand-alone receiving system to receive and process broadcast television signals. In the case of broadcast signals received by a stand-alone receiving system, signal processing functions for the received broadcast signal are all carried out by the stand-along receiving system including demodulation, transport-stream demultiplexing, decompression, and error correction. In this mode of operation, the display device (14 or 14′) acts as a video monitor, receiving and displaying the processed signals output by the stand-alone receiving system, e.g. via an HDMI input to the display device.

ATSC is a set of standards developed by the Advanced Television Systems Committee for digital television transmission that replaced much of the analog (NTSC) television system on Jun. 12, 2009 in the United States. The ATSC standards also have been adopted by other countries including Canada, Mexico, South Korea and Taiwan. ATSC standards govern digital terrestrial television, which broadcasts land based (terrestrial) signals. Furthermore, when used in digital cable television in areas governed by the ATSC standard, the format of data transmitted using QAM modulation is based upon ATSC. Many aspects of ATSC digital television reception are patented. The activation of the ASTC tuner renders these patented aspects operable in the activated digital television receiver. Hence ATSC tuner activation may provide an appropriate basis to register the activated DTV for license reporting purposes.

The ATSC tuner 46 in the display device 14 is only used to process and decode certain kinds of signals. If the end user 18 (FIG. 1) does not receive ATSC signals, for instance using the display device 14 to receive only signals from a set-top box or other non-ATSC types of signals, such as signals from a computer or a video playback device such as a DVR, a DVD player, or a Blu-Ray player, the ATSC tuner 46 is a superfluous part of the system 40, destined to remain unused by the end user 18. Since operation of the ATSC tuner 46 may require payment of certain licensing or other fees, it would be advantageous not to activate the ATSC tuner 46 in those situations where it would not be used. This would allow payment of licensing or other fees associated with the operation of the ATSC tuner 46 to be made only in situations where the ATSC tuner 46 was actually used. In addition such an activation procedure may be used to gather information on how the display devices are used, for example including the fraction of devices in which the ATSC tuner is activated, as well as information such as the geographic distribution of the activated devices, and/or information regarding how long after purchase the ATSC tuners are activated in such devices.

Digital cable broadcast in North America is governed by standards ITU-T Recommendation J.83B and ANSI/SCTE 07 “Digital Video Transmission Standard for Cable Television.” ANSI/SCTE 07 describes the framing structure, channel coding, and channel modulation for a digital multi-service television system using a cable channel. The specification covers both 64 and 256 QAM. Various aspects of QAM digital television reception in accordance with these standards are patented. As with ATSC tuner activation, the activation of the QAM tuner renders these patented aspects operable in the activated digital television receiver, and QAM tuner activation provide an appropriate basis to register the activated DTV for license reporting purposes.

Although the activation process has been described above in terms of the activation of an ATSC tuner as well as a QAM tuner, it will be appreciated that similar considerations may come into play in a wide variety of features of various display devices. Such features may be made initially deactivated, with an activation process used to enable use of one or more features. As described both above and below, the activation device may include sending notification information to an activation service, allowing a record to be kept as to how many and which of the display devices have the initially-deactivated feature activated.

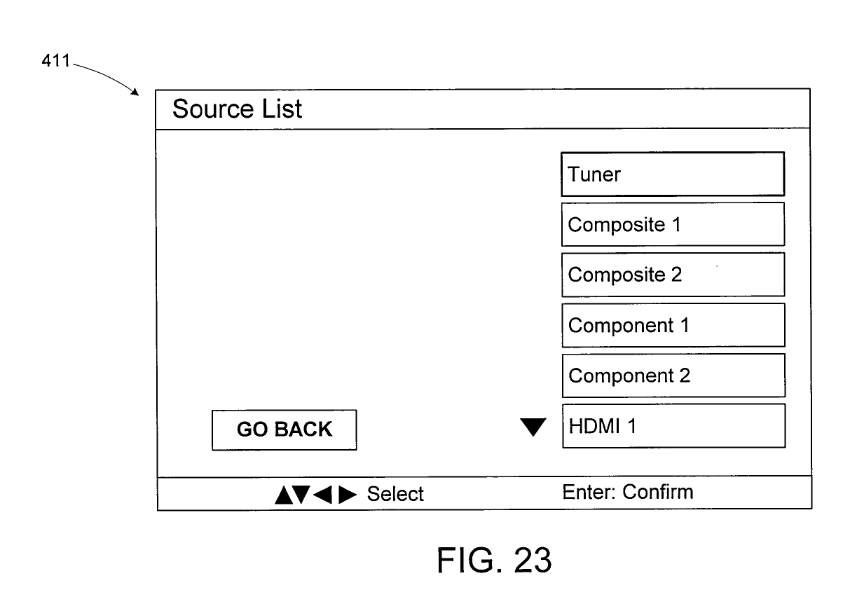

Besides tuners, another type of display device feature that may be initially deactivated and may be activated by an end user is an audio/video connector, which provides an audio/video interface with a source device. A DTV can be provided to an end user with a digital audio/video connector in a deactivated state, incapable of processing audio/video input signals. An end user may select the audio/video connector for use during set-up, for example via the input selector screen of FIG. 23. In response to this selection, the DTV would initiate a procedure to activate the audio/video connector (or set of connectors of a given type). Various types of digital audio/video connectors for display devices, such as HDMI-in connectors, operate under software control and power and may be activated using control circuitry similar to the following description of FIGS. 2A and 2B.

With regard to the ATSC tuner 46, the tuner 46 may be initially deactivated by not supplying power to the ATSC tuner 46. For example, as shown in FIG. 2A the system 40 may include a smart switch 76 that controls the supply of power to ATSC tuner 46 under the control of television controller 74. (FIG. 2A also shows a separate QAM tuner 48, and a smart switch 77 to control the activation of this tuner.) Alternatively the initially inactivated ATSC tuner 46 may receive power but may be inactivated via software control of the tuner's functionality.

In the single tuner system 91 of FIG. 2B, a smart switch 76 controls the supply of power to dual-function tuner 92 under the control of a television controller 74. Alternatively, the initially deactivated dual-function tuner 92 may receive power but may be inactivated via software control of the tuner's functionality. In addition as previously noted, RF input mode control by the television controller 74 determines whether the tuner 92 is activated to provide ATSC tuning or to provide QAM tuning. Only one type of activation is possible at one time.

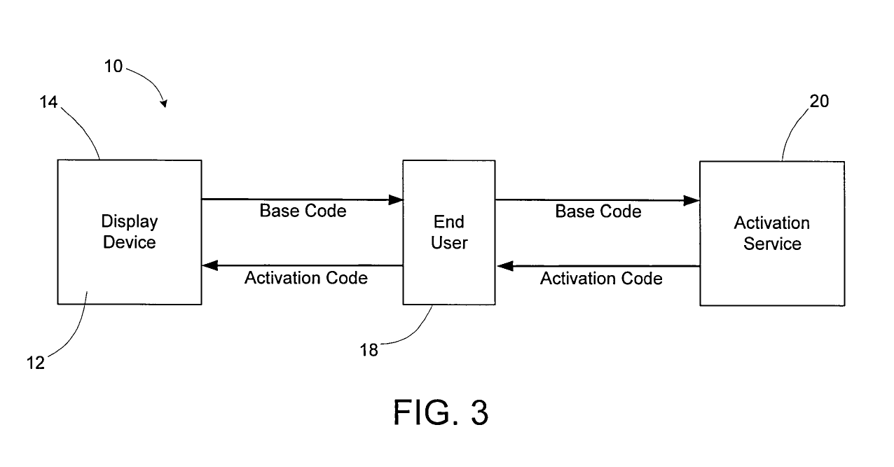

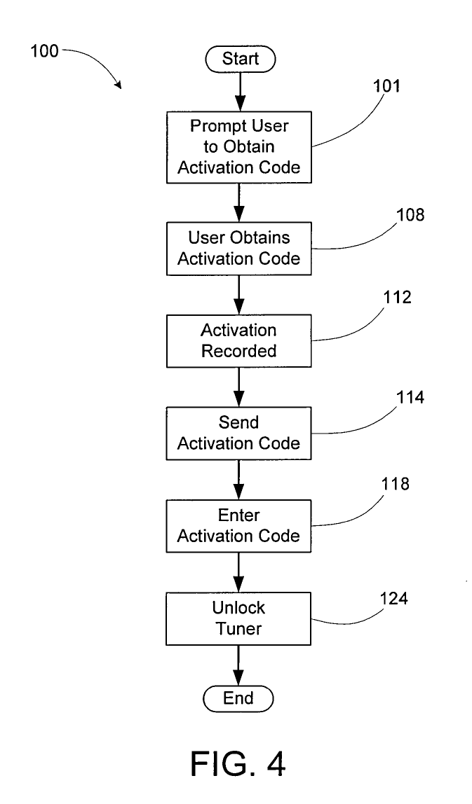

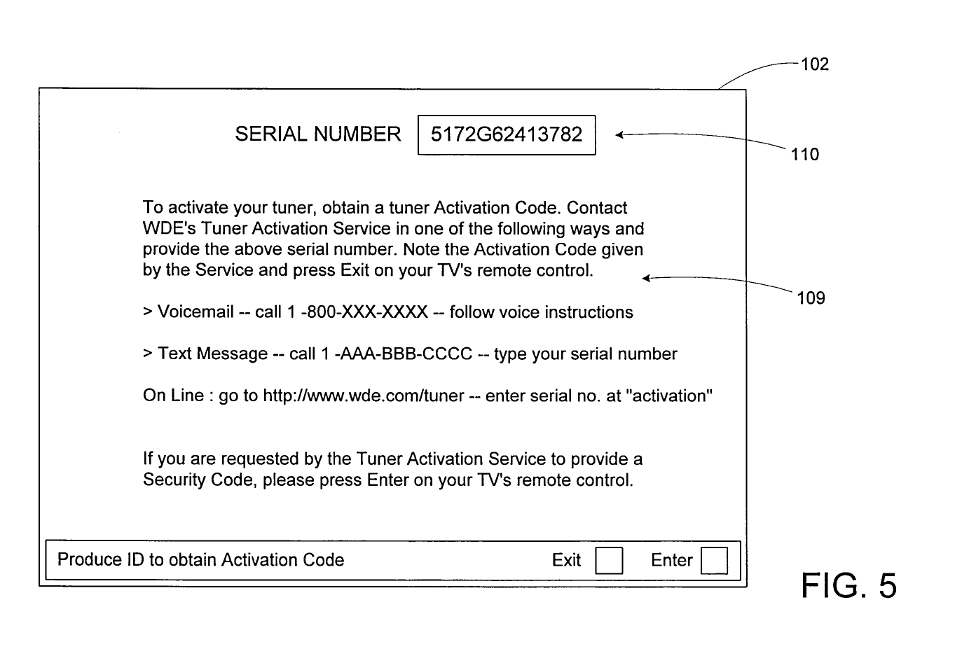

As discussed above, there are many possible ways for the activation of the initially-deactivated feature to be performed. FIGS. 3 and 4 illustrates a first method 100 of activation, wherein the display device 14 provides a prompt in step 101 to the end user 18 to obtain an activation code as part of the process of activating the initially-deactivated feature. An example of a prompt 102 is shown in FIG. 5. The prompt 102 may be provided as part of the initial set up of the display device 14, or when a new audio video source is connected to the display device 14. The process of the display device 14 being able to recognize and interpret signals from newly-connected signal sources is described in greater detail in co-owned patent application publications US 2006/0221254 A1 and WO 2007/112188 A2, the specifications and figures of which are incorporated herein by reference in their entireties.

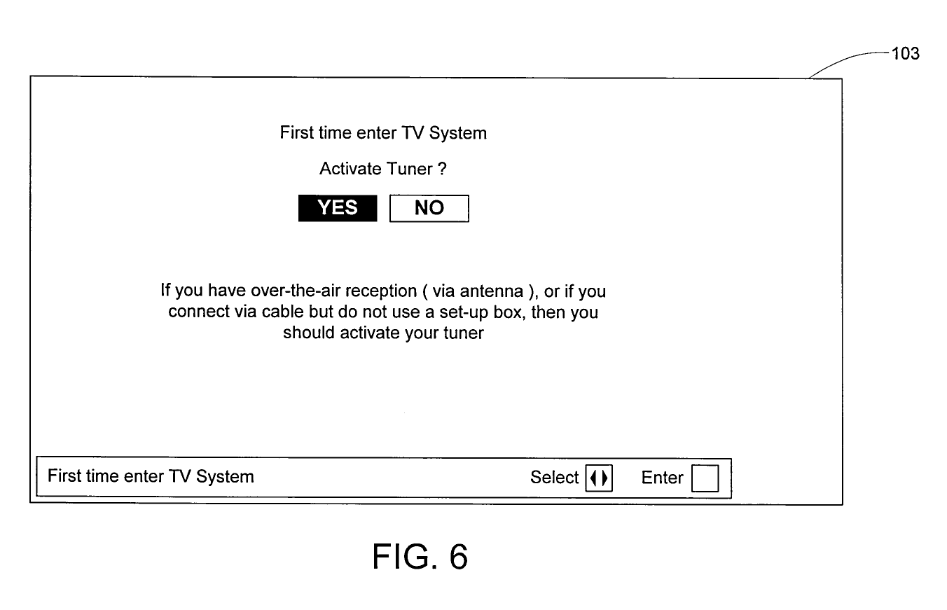

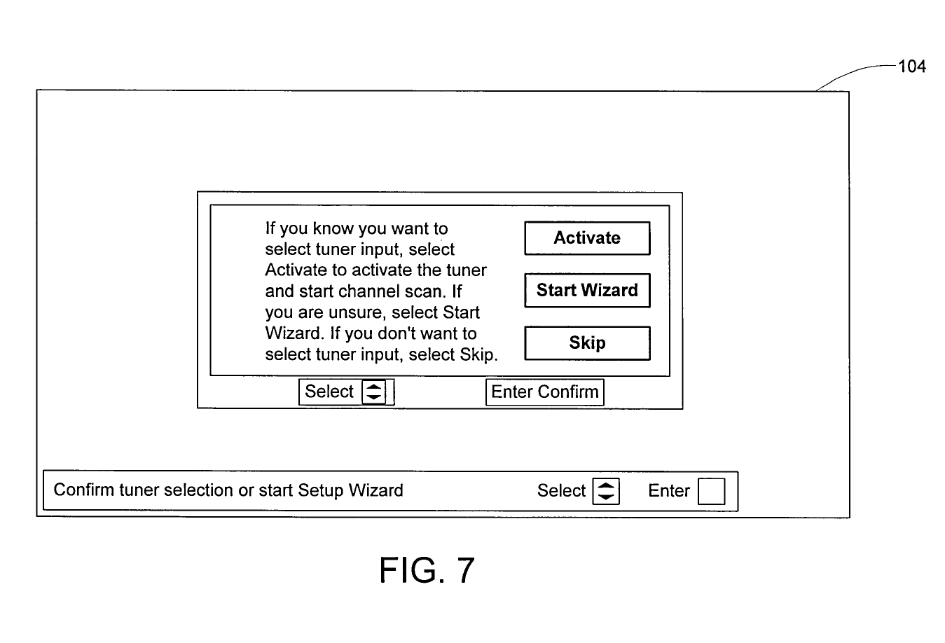

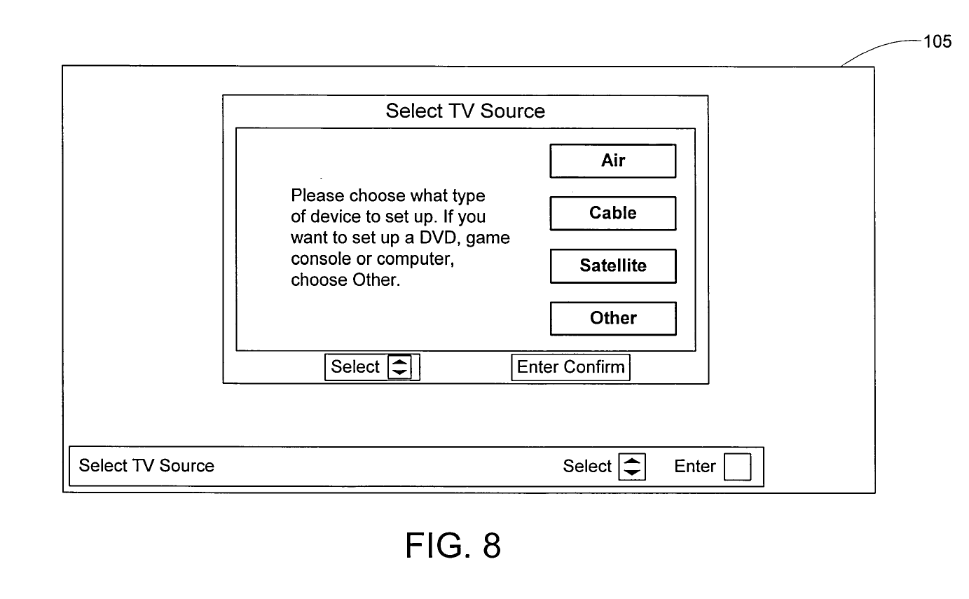

It will be appreciated that only use of audio video sources that require the ATSC tuner 46 (FIG. 2A) triggers the activation process of the method 100, although a similar process may be used for activation of QAM tuner 48 or other initially-deactivated feature. The end user 18 may be prompted as to the type of source, and further prompted regarding details of the source, in order to determine whether the ATSC tuner 46, QAM tuner 48, or other initially-deactivated feature, needs to be activated. For instance, if the end user 18 indicates that an over-the-air signal is to be used, the activation process may be initiated. FIGS. 6 and 7 show examples of interactive prompts 103 and 104 to elicit this sort of input from the end user 18. In the prompt 103 in FIG. 6 the user is provided with information about when tuner activation is necessary, and is given the option of initiating activation. In the prompt 104 in FIG. 7 the end user 18 is given the option of initiating activation, or of using a wizard to determine if tuner activation is warranted. FIG. 8 shows a prompt 105 that is part of such a wizard, prompting the end user 18 to enter the type of device being set up. If the user indicates that an over-the-air signal is being use, the tuner activation method 100 is initiated. If satellite or “other” sources are chosen, there is no need for tuner activation. If the end user 18 indicates that a cable signal is to be the source, further prompting, such as the prompt 106 shown in FIG. 9, may be used to clarify whether a set top box will be used (in which case no tuner activation is required) or if a cable with a signal requiring the QAM tuner 48 will be directly input into the display device 14. In the latter case, activation of QAM tuner 48 will be initiated; in a procedure generally similar to that used for activating ATSC tuner 46 as described below. It will further be appreciated that the process of determining whether activation is necessary may be automated completely or in part. For example the ability to detect and/or interpret signals from a newly-connected cable signal source may be used to make a determination as to whether the QAM tuner 48 will need to be activated. Such a determination may be subject to confirmation and/or alteration by the end user 18. The automation, in whole or in part, of the process of determining whether activation will occur, may aid in avoiding unnecessary activations of ATSC tuners or other activatable display device features. Unnecessary activations may waste the time and effort of end users, may result in payment of excessive license fees or other fees, and/or may skew marketing data.

In step 108 the end user 18 makes a request to the activation service 20 for an activation code to allow the activation process to proceed. The prompt 102 may contain information 109 on how to contact the activation service 20 to obtain the activation code or other activation information. The communication between the end user 18 and the activation service 20 may be by any of a variety of suitable methods, examples being by telephone, by text message, or over a computer network system such as the Internet. Communication over the Internet may be by way of using a browser on a separate computer to visit a web site, or by using electronic mail. Multiple methods of contact may be available, with the prompt 102 possibly providing information on multiple contact methods. Other possible ways of communicating activation service contact information to the end user 18 include in a manual or other documentation provided with the display device 14, or on the manufacturer's web site (which may link to a web site of activation service 20). The end user 18 may communicate with the activation service 20 by any of these methods.

The request to the activation service 20 may include one or more codes and/or keys that is/are confirmed by the activation service as a precondition to issuing an activation code. Such information is referred to herein as a “registration code.” Preferably the registration code uniquely identifies or otherwise identifies the display device 14. A serial number is an example of a unique identifier for the display device 14. As is shown in FIG. 5, the serial number or other identifier (registration code) 110 may be provided to the end user 18 as an element of the prompt 102. Alternatively the user 18 may be prompted to obtain the serial number or other identifier, such as from the display device 14 itself, or from documentation accompanying the display device 14.

The registration code (which may include numbers and/or letters or other symbols) may be provided by the end user 18 to the activation service 20 in any of a variety of means, such as by keying in the number using a keyboard or other data entry device or mechanism, or by using a telephone keypad or voice prompts to enter the serial number or other identifier (registration code). The requirement for a registration code to be provided to the activation service 20 prevents spurious activation attempts being made by those not owning or having access to a display device 14. In addition the requirement allows multiple activation attempts for the same display device to be counted as only a single activation for purposes of determining how many display devices have been activated, such as for purposes of determining licensing or other fees. It will be appreciated that a serial number or other registration code may easily be included in the memory of the display device 14, so as to be easily located and called up during the activation process.

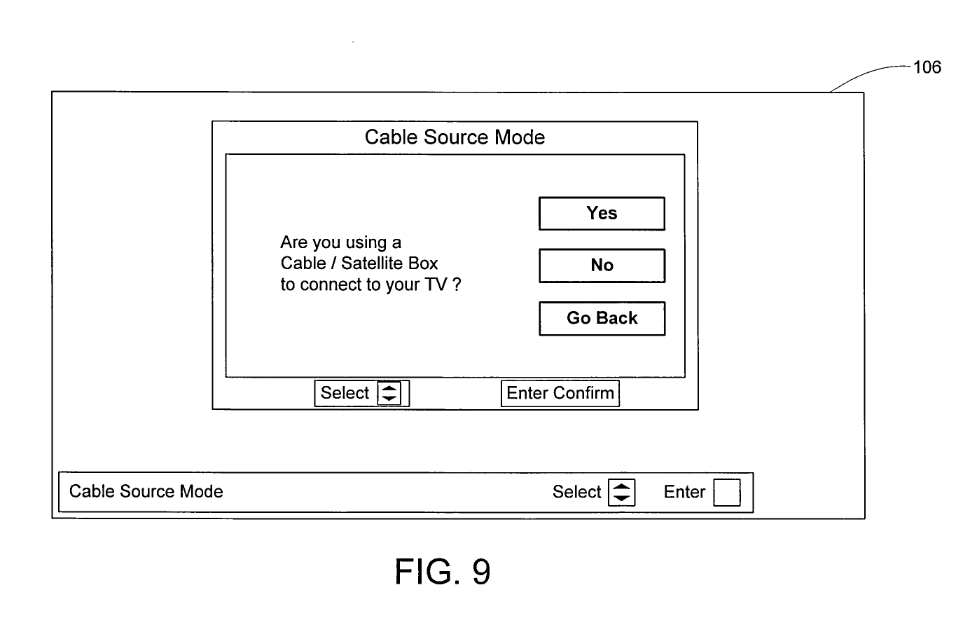

In step 112 the activation is recorded by the activation service 20. In step 114 an activation code or other activation information is provided by the activation service 20 to the end user 18. The activation code provided in response to the registration code may be an individualized activation code usable for only the specific display device 14, or some subset of the total number of similar display devices (display devices having the same manufacturer and perhaps the same model). After the activation code is provided, in step 118 the activation code may then be entered into the display device by the end user 18. FIG. 10 shows an activation code entry screen 120 where the activation code is entered. The activation code may be an alphanumeric code that is entered by use of a remote control or other device operatively coupled to the display device 14.

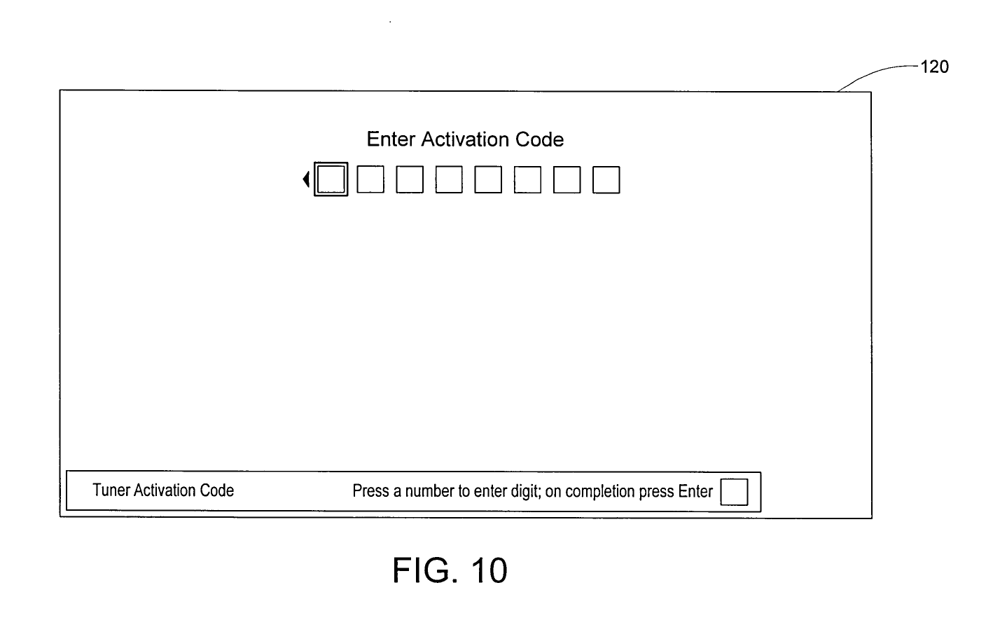

In step 124 the activation is completed by unlocking the ATSC tuner 46, and allowing operation of the ATSC tuner 46. An algorithm may be included in the hardware and/or software of the display device 14 to evaluate the activation code, and determine whether it is an acceptable activation code for that particular display device 14. The algorithm may accept any of several possible activation codes, with the registration code being an input for determining whether the activation code is proper. As an alternative, one or more acceptable activation codes may be stored in the memory of the display device 14 during manufacture. The use of multiple possible activation codes for a single display device 14 aids in preventing reverse engineering to determine the encryption or method used to produce the activation code. FIG. 11 shows a confirmation screen 126 that informs the user 18 that the entered activation code was accepted, and that the tuner has been activated.

The activation of the ATSC tuner 46 may include activating certain portions of the display device 14 that are necessary for operation of the ATSC tuner 46. With reference to FIG. 2A, this may include activation of the ATSC demodulator 56 and/or the ATSC decoder 58.

Following activation of the tuner 46 other suitable operations may be performed as part of a set up process. An example is a channel scan using the newly-activated ATSC tuner.

Instead of or in addition to a serial number the identifier may be or may include a registration code based on the serial number or other identifier. The registration code may be based on the Extended Display Identification Data (EDID) of the display device 14 (FIG. 1) being activated. It may be advantageous to use a number based on the serial number or other identifier, rather than the serial number or identifier itself. This may prevent spurious activation counts from use of purloined serial numbers (or other identifiers), for example obtained from packaging materials of unsold display devices.

The requirement to have the activation code in order to accomplish the activation prevents activation without contact to the registration service 20 (FIG. 1). By using activation codes that are keyed to the registration code, reuse of activation codes on different display devices may be reduced or altogether prevented. It is envisioned that the activation process may not require any sort of payment by the end user 18, although a pay-to-activate procedure may be possible. If payment is required it will be appreciated that it can be accomplished by credit card or by Internet payment services such as PAYPAL. It will be appreciated that some end users may attempt to activate without contacting the activation service 20, whether or not payment from them is required. The requirement for an activation code prevents this.

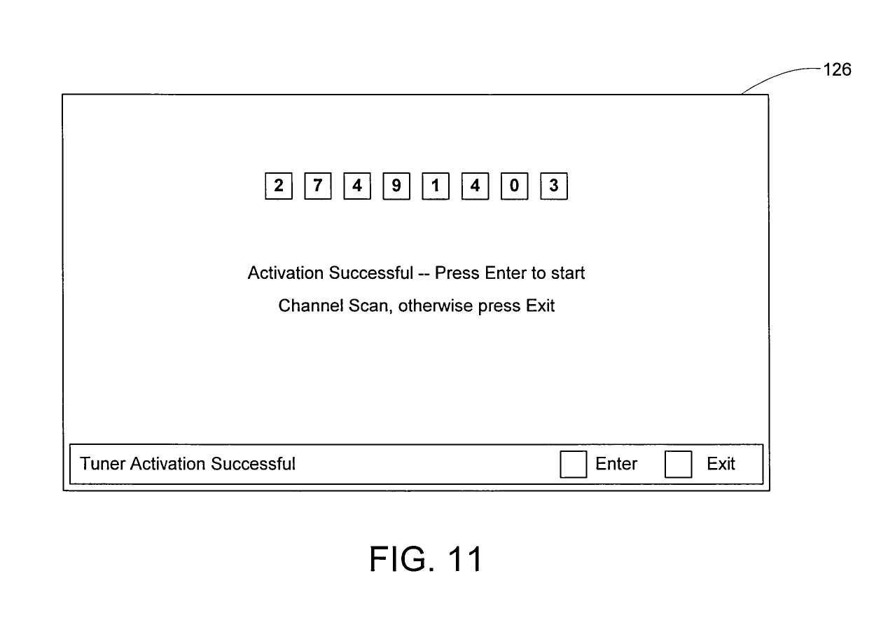

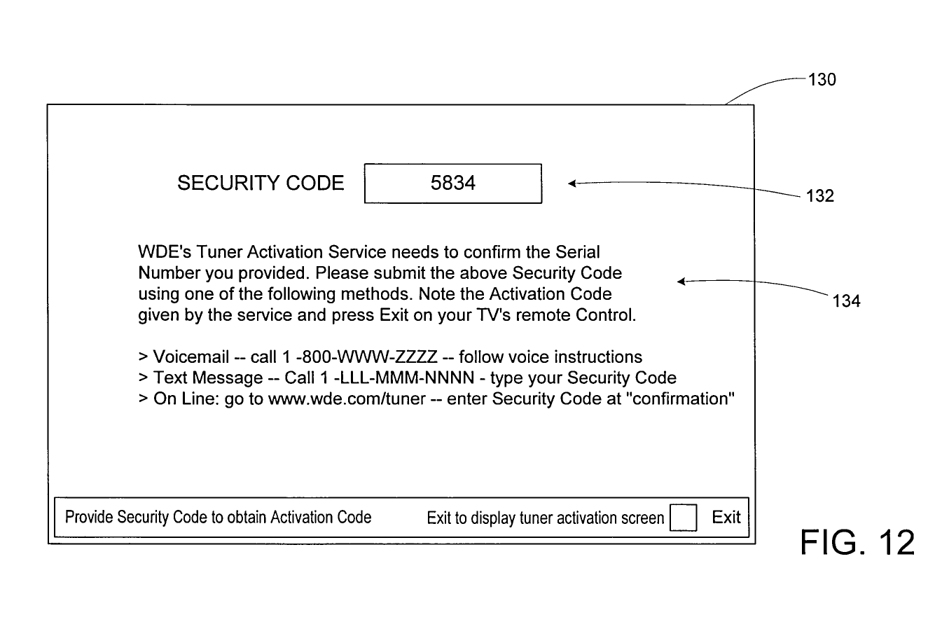

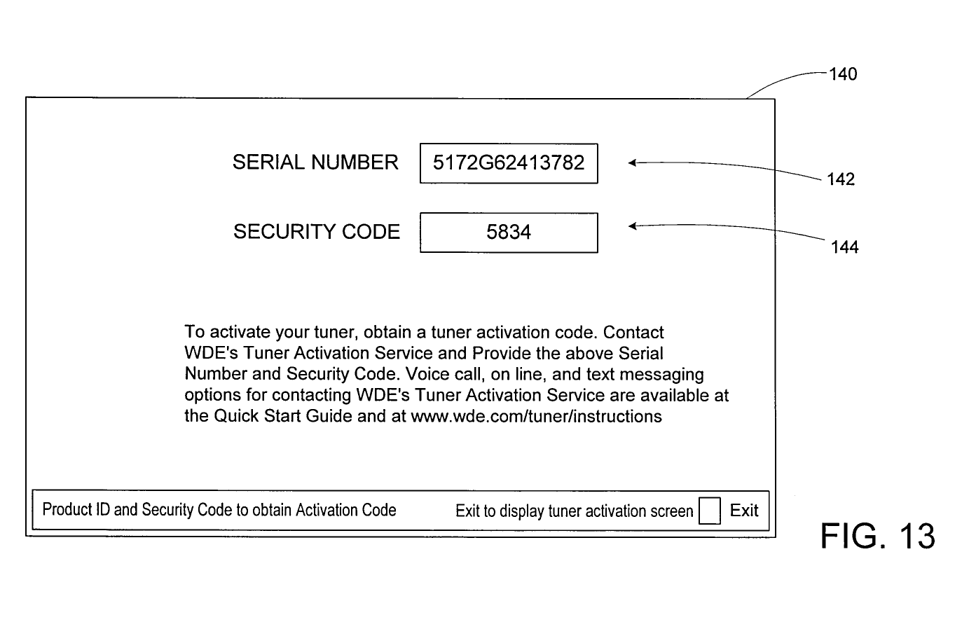

The requirement to provide a registration code as part of the activation process helps in preventing spurious activation attempts. It also aids in identifying multiple activation attempts for a single display device. Such multiple attempts should be counted as only a single activation, for purposes of tabulating license fees or other fees. In addition it will be appreciated that additional information may be required from an end user once multiple attempts to activate the same display device 14 are detected. For example the end user may have to provide an additional authentication or security code when multiple attempts to activate the same display device 14 are detected. FIGS. 12-14 show examples of ways of providing the end user 18 with the authentication or security code. FIG. 12 shows a prompt screen 130 which lists the security code 132 and contact information 134. As an alternative, with reference to FIG. 13, an activation prompt screen 140 may include both a registration code (here a serial number) 142, and a security code 144 to be used if necessary. FIG. 14 shows a further alternative, a screen 150 that prompts activation by providing the registration code 152 with instructions 154 as to where to find the security code on a tag or label on the display device 14. It will be appreciated that other alternatives are possible, such as placing an authentication or security code in documentation accompanying the display device 14.

It will be appreciated that a wide variety of coding techniques may be used in generating and interpreting the registration codes and/or the activation codes. Such techniques may include cryptographic hash functions and other encryption and decryption techniques.

The registration codes and/or activation codes may be based on any of a variety of alphanumeric codes associated with the display device 14. Examples include one or more of universal product codes (UPCs), manufacturer's codes, product ID codes, serial numbers, and EDID data (including, for example, fields for the manufacturer's name (or an abbreviation thereof), a product identification code, all or a portion of the serial number, the week of manufacture, and the year of manufacture). EDID data may be stored in memory at the time of manufacture of the display device 14, for example being stored in EEPROM.

The registration codes, information derived from the registration codes, or information provided by the end user 18, may be saved at the activation service 20. Such information may be stored on any of a variety of computer-readable media, for example. Information regarding activation may be aggregated and/or condensed, and provided to appropriate of the third parties 24. For example the number and type of display devices activated may be provided both to a manufacturer and a licensee or other party due license fees or other fees. Additional information may be provided as needed or desired to properly determine the fees due. Examples of such additional information include the models which have had their features activated, or some relevant characteristic of the activated devices, such as screen size.

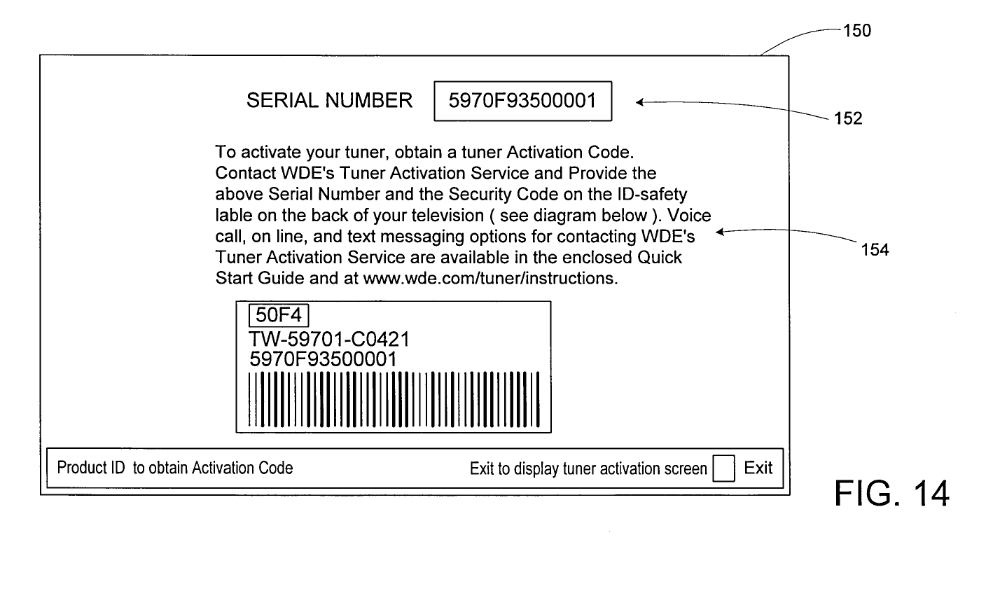

FIG. 15 illustrates an alternative activation system/method 10 in which the display device 14 communicates directly with the activation service 20. The display device 14 may send the registration code directly to the activation service 20, and receive the activation code directly from the activation service 20. The communication may be by a computer network, such as the Internet, to which both the display device 14 and the activation service 20 are coupled. Alternatively the communication may be by telephone. For example the display device 14 may include an internal telephone, such as a prepaid cellular telephone, that may be utilized to accomplish communication with the activation service 20, perhaps solely for the purpose of accomplishing the activation by sending the registration code and receiving the activation code. The display device's transmission of the registration code may occur in response to a user instruction as shown in FIG. 15, or may occur automatically upon a display device event (e.g. recognition of a new input source) indicating the need for activation. The method illustrated in FIG. 15 has the advantage of being automatic, and thus being faster, with little or no effort from the end user 18, and with less chance of error (by removing the need for the end user 18 to relay either the registration code or the activation code). No effort on the part of the end user 18 may be required at all, although it will be appreciated that the end user 18 may have the opportunity to authorize the contact with the authorizing service 20 prior to the initiation of contact.

The method illustrated in FIG. 15 may be combinable with the methods described above that involve more participation by the end user 18. A direct connection between the display device 14 and the activation service 20 may be the preferred method of activation, when available. Toward that end, the display device 14 may be able to determine whether a computer network connection or telephone connection with the activation service 20 is available, and prompt the end user for such an activation process if a direct connection is available. The determining of the availability of a connection may include determining whether the display device is connected to a computer network such as the Internet, and/or whether a cellular phone signal of sufficient strength is available. If a direct connection is not available, or if the end user 18 does not wish to utilize an available direct connection, the display device 14 may prompt the end user 18 to initiate the process described above in FIGS. 3-5 for making contact with the activation service 20 to obtain an activation code to be input to the display device 14.

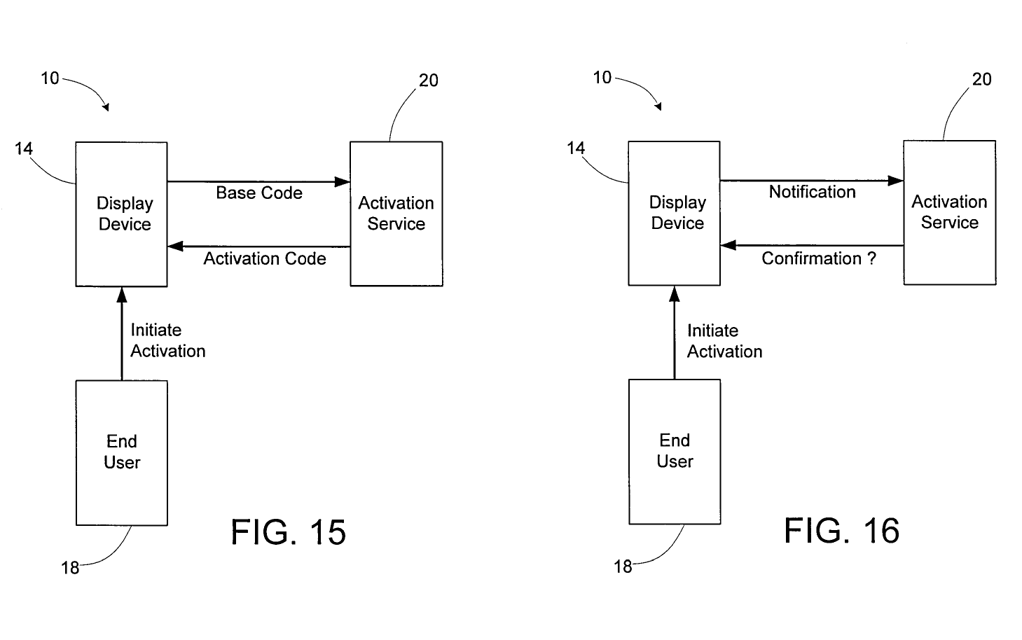

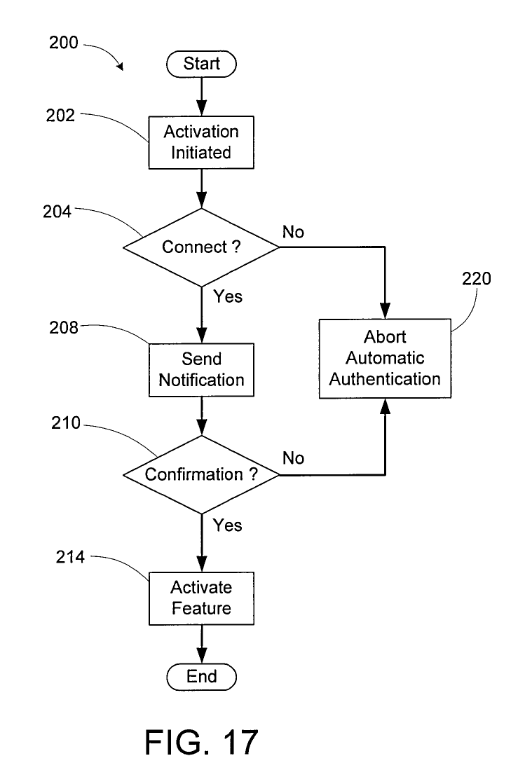

FIGS. 16 and 17 illustrate another alternative, an activation method 200 in which no activation code is required. In the method 200 the display device 14 communicates directly with the activation service 20, such as by a computer network such as the Internet, or by telephone, such as a cellular telephone internal to the display device 14. However, unlike the activation methods described above, in the method 200 no device-specific information from the activation service 20 is required to complete the activation process. Instead the necessary interaction between the display device 14 and the activation service 20 may consist only of a notification that activation has been initiated or completed.

The method 200 begins when the end user 18 initiates the activation process, in step 202. The initiation may be part of a set up or configuration process, in which the end user 18 has made a connection or made a selection which indicates that the ASTC tuner 46 (FIG. 2A), or other initially-deactivated feature, is to be activated. Examples are described above with regard to the method 100. Then in step 204 the display device 14 may check for a connection with the activation service 20, and/or may initiate a connection with the activation service 20. The connection may be made by computer network or telephone, as appropriate. If a connection is successfully made, then in step 208 a notification of the activation is sent from the display device 14 to the activation service 20. The notification may be an alphanumeric string or the equivalent, and may include the registration code described above, in any of a variety of suitable forms. In addition the notification message may include other information regarding the display device 14, such as the EDID of the device 14, or various settings of the device 14.

In step 210 the display device 14 may receive a confirmation message from the activation service that the notification message was received and that the information in the notification message is in order. It will be appreciated that the system and method may be configured to operate without use of a confirmation message, although use of a confirmation message may add reliability to the system. The confirmation message may be a simple notification of confirmation, or may include other information, such as a code that may be stored in the display device 14 for future use.

After the sending of the notification method and the possible receipt of the confirmation method, the activation proceeds in step 214 with activation of the initially-deactivated features, such as the ATSC tuner 46 (FIG. 2A). If either the connection with the activation service 20 cannot be made, or if a confirmation message is not received (if one is used), then the automatic activation may be aborted, as indicated in step 220. An abort of the automatic activation method may initiate a manual activation method requiring more involvement of the end user 18, such as the method 100 described above with regard to FIGS. 3-5.

It will be appreciated that many variants are possible in the method 200. For instance the sending of the notification may occur after activation of the initially-deactivated feature of the display 18. Multiple attempts at notification may be made until a successful notification is accomplished, or until some threshold of failed attempts or time is reached. If activation is accomplished, and a subsequent attempt or attempts at notification fail, the end user 18 later may be prompted to obtain and enter an activation code, as described above in the method 100, to continue use of the activated feature.

It will be appreciated that the notification-based activation method 200 may have advantages over the method 100 by being faster, by requiring less effort on the part of the end user 18, and by being less prone to errors, to name some of the possible advantages. The method 200 may be completely transparent to the end user 18, who may not even be notified that an activation or notification process is occurring.

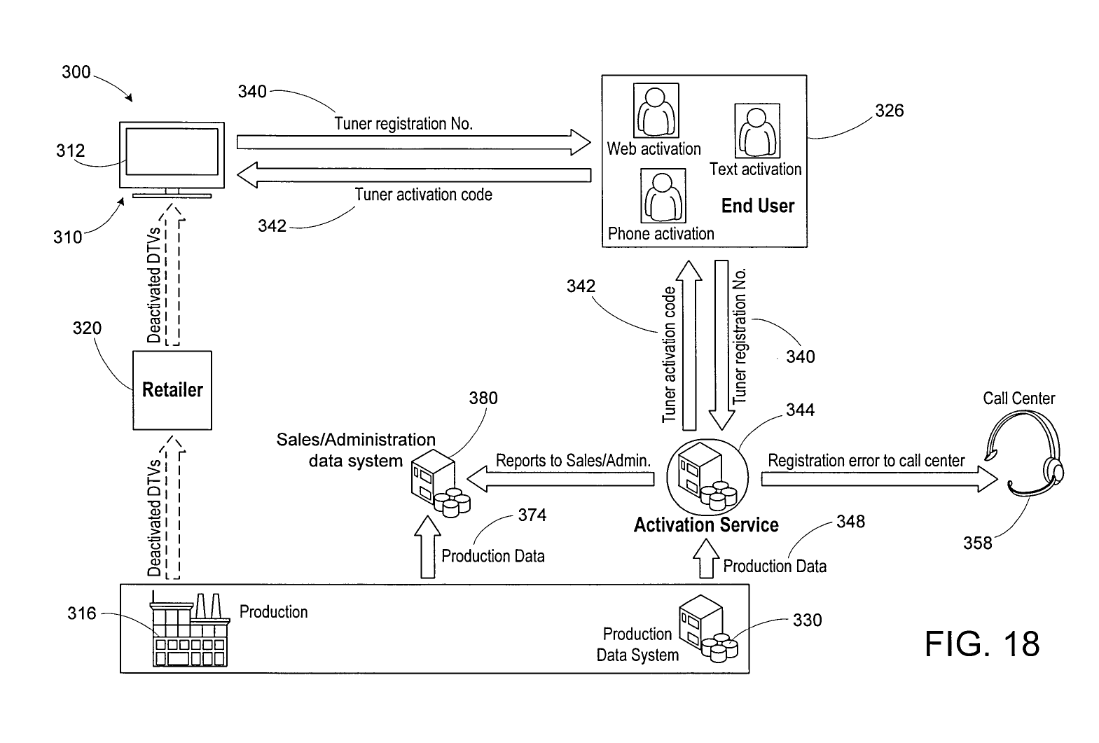

FIG. 18 schematically illustrates a working embodiment of a system 300 for activating an initially-deactivated tuner 310 of a digital television (DTV) 312. Data flows are shown with solid arrows, while materials flows are shown with dotted line arrows. DTVs with initially-deactivated tuners are manufactured at production site 316, which delivers the DTVs to a retailer 320. The retailer 320 sells or distributes the DTVs, still with initially-deactivated tuners, to customers such as an end user 326.

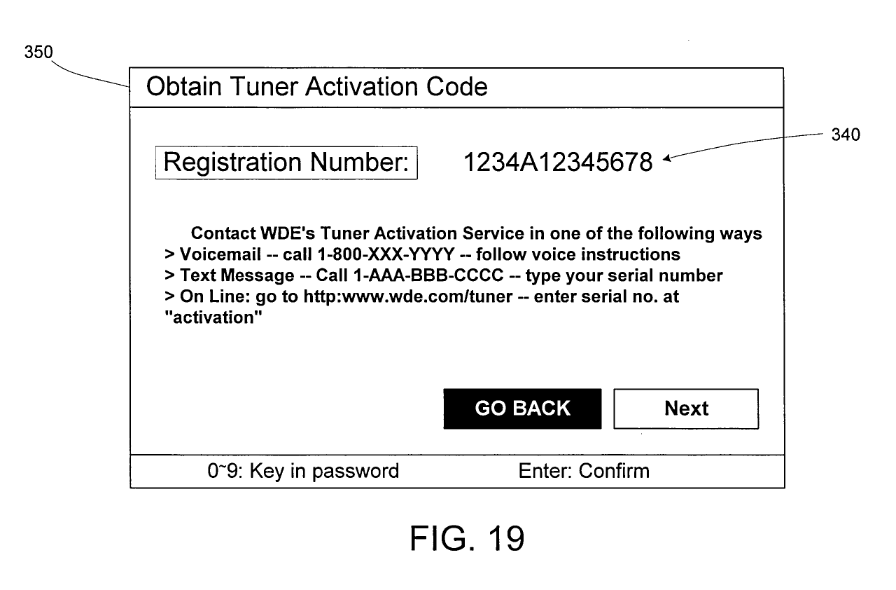

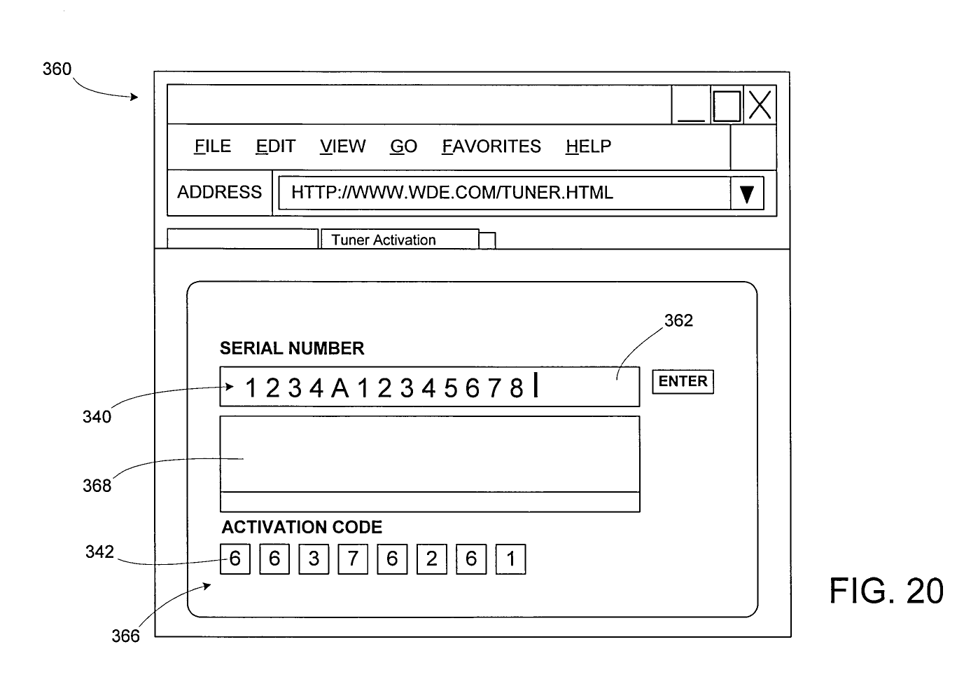

The production site 316 includes a production data system 330 that stores information pertaining to produced DTVs. The production data may include a unique serial number 340 (FIG. 19) for each DTV. The serial number 340 may be based upon a thirteen character format, as shown for example in FIGS. 19-20: 1234A12345678. In this example the first four digits are the product ID code of the Video Electronics Standards Association (VESA) EDID standard; this code is assigned by the manufacturer. The fifth digit is a factory ID for production site 316. The sixth digit is a year code, and the seventh and eighth digits are a week code. The ninth through thirteenth digits are a unique code for each DTV produced at production site 316 during the time period corresponding to the year code and week code.

In the system 300 for activating an initially-deactivated tuner of FIGS. 18-21, the thirteen character serial number for each DTV serves as a tuner registration number 340 for that DTV. As is conventional, the serial number (registration number) 340 is stored in a memory device of the DTV such as serial PROM (programmable read-only memory) or EEPROM (electrically erasable programmable read-only memory).

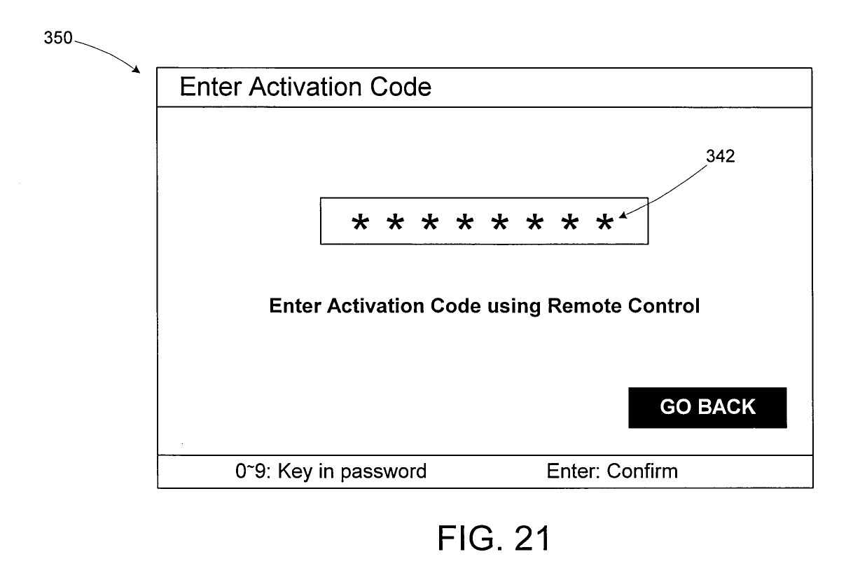

The production site 316 may use a deterministic random bit generator (DRBG) to generate an activation code. The DRBG is an algorithm generating a sequence of numbers which approximates the properties of random numbers. The DRBG uses each registration number (serial number) as a seed to generate the corresponding activation number or code 342 in a deterministic method. In the illustrated embodiment the activation code is an eight character alphanumeric code (FIGS. 20-21). Activation codes between five to ten characters in length are advantageous based upon tradeoffs between user convenience and security.

The DRBG may be an external device (not shown) that generates the activation code 342 from the serial number 340 at a production line station in which the serial number is written to PROM, and that writes the activation code to another memory register of the DTV. The DRBG may be an external device (not shown) that generates the activation code 342 from the serial number 340 at a production line station in which the serial number is written to PROM, and that writes the activation code to another PROM memory register of the DTV. The activation code 342 in effect serves as a password to enable a user to activate the initially-inactivated tuner 310. In prior art DTVs one or more passwords of the DTV, such as a system password that can be used for example to access parental control functions, are available to the end user by accessing system data of the DTV. By contrast in the present DTV (or other display device) 312, the tuner activation code 342 is hidden from the end user and can only be accessed via an activation service 344.

The same DRBG algorithm that is used by production site 316 to generate tuner activation codes in production of DTVs is also used by the activation service 344 to issue activation codes 342 to end users 326 based upon registration numbers 340 received from the end users 326. As used in the activation service's algorithm for issuing activation codes, the DRBG may be combined with other procedures. For example, the production data system 330 may transmit production data 348 (e.g. weekly batch files) to the activation service 344. The production data 348 may contain serial numbers 340 of all initially-deactivated DTVs produced at that site. The activation service 344 may maintain a master log of the serial numbers of all initially-deactivated DTVs produced by that manufacturer. If a serial number 340 submitted by an end user 326 does not appear in the serial number master log, the activation service 344 may not issue an activation code 342, even though the serial number 340 might otherwise generate a code using the DRBG algorithm.

In the system 300 of FIG. 18, the initially deactivated DTV (or other display device) 312 does not support direct communications (e.g. via the internet) with the activation service 344, and end user 326 acts as intermediary. End users 326 may have the option of telephonic, text, or web communication with the activation service 344 for tuner activation purposes. As seen in FIG. 19, the registration number (serial number) 340 is displayed on a screen 350 of the DTV 312 during set up, and the DTV 312 can provide instructions for communicating with the activation service in order to obtain a tuner activation code. For example the user 326 may use an automated dial up service to obtain the activation code 342, and if the registration number 340 is not recognized (perhaps after repeated attempts) the activation service 344 may refer the end user to a customer service agent at a call center 358 (FIG. 18).

FIG. 20 illustrates a web site that an end user 326 (FIG. 18) may access to obtain an activation code 342. A web page 360 may be maintained by the activation service 344, or may be a manufacturer's web page that links to the activation service 344. The web page 360 prompts the end user 326 (FIG. 18) to enter the registration number or serial number 340, at 362. If this number is recognized by the activation service's (DRBG) algorithm, the web page 360 displays the activation code at 366. In this event the activation service 344 may also transmit the activation code to the user via an alternative channel, such as a text message. On the other hand if the activation service 344 does not recognize the serial number 340, the web page 360 may display an error message or troubleshooting instructions in the window 368. The web page 360 also may include a window or form to accept user information concerning a failure to issue an activation code. In addition web site may provide related end user services, such as information about over-the-air broadcast reception in the end user's geographic area.

FIG. 21 shows a DTV screen 370 for entering the activation code 342, e.g. via remote control. This DTV screen 370 may display end user instructions (not shown) in the event the activation code is not recognized.

The system 300 (FIG. 18) includes data sub-systems that facilitate license reporting and audit for license agreements that depend on tuner activation transactions. A production data system 330 provides serial numbers of produced DTVs and other production data 348 to the activation service data system of the activation system 344, and provides production data 374 to the manufacturer's sales/administrative data system 380 (not necessarily the same data to both). Production data can include for example firmware version numbers that track the tuner control firmware in the DTV. This firmware version number can indicate for example which DTVs include initially-deactivated features, what feature (e.g. ATSC tuner, QAM tuner) is deactivated, and what (DRBG or other) algorithm is used to generate tuner activation codes. In addition production data can include additional data used in license reporting, e.g. for calculating royalty, such as DTV size.

Additional data for license reporting purposes also may reside at the sales/administration data system 380. For example this may include data on sales to the retailer 320 (and other retailers), and registration data submitted by end users 326 that register their purchases of DTVs. In the embodiment of FIG. 18, the manufacturer 316 is responsible for license reporting to intellectual property holders, and the activation service 344 sends tuner activation reports 384 to the manufacturer's sales/administration center 380 to support license reporting.

Alternatively the activation service 344 itself may issue license reports to intellectual property holders, acting as a trust authority that can service activation for multiple display device manufacturers and/or multiple intellectual property holders. In this embodiment (not shown in FIG. 18), the production site may send additional production data to the activation service, and the sales/administrative center(s) may send data (e.g. sales data) to the activation service for license reporting purposes.

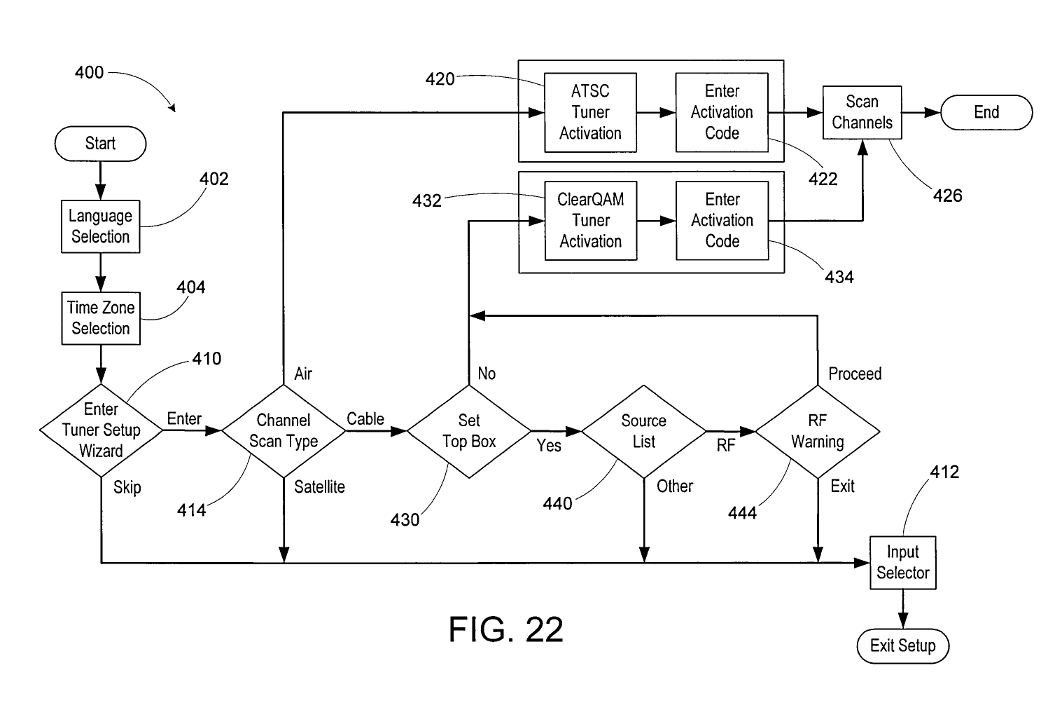

FIG. 22 shows a flow chart of a process/system/method 400 for initial setup of the input to a display device. The set-up procedure described below involves a series of prompts and user selections (set-up wizard), but certain user selections may be unnecessary in an alternative procedure in which the system automatically detects certain information, such as the automatic DTV input selection techniques described above. The flowchart of FIG. 22 shows the integration of certain novel steps surrounded by borders, i.e. the ATSC tuner activation steps 420 and 422 and the QAM tuner activation steps 432 and 434, into a preexisting DTV setup process. In step 402 the end user makes a language selection. In step 404 the user makes a time selection.

Then the user makes a decision whether to enter a tuner setup wizard in step 410.

If the user skips the tuner setup wizard the setup process 400 directs the user to an input selector screen, such as the source list screen 411 of FIG. 23, to select the input to the DTV. Typically at this step the user would select a source that does not require a tuner such as connector to a set-top box, DVD player, or Blu-Ray player, and suitable inputs may include HDMI, Component, or Composite video. Note however that if the user selects the “Tuner” option at the top of the Source List, whether during the user's initial setup of the DTV or later during the service life of the DTV, the DTV's controller determines whether the tuner has been activated and if not, prompts the user to initiate the tuner activation wizard. Thus in the initial setup procedure of FIG. 22, if the user declines to use the tuner setup wizard at step 410 but then selects “Tuner” input at step 412, the system transfers the user back to the Enter Tuner Setup Wizard step 410.

If the tuner setup wizard is entered, at step 414 the user identifies what type of input signal the display device is receiving, including air, cable, or satellite, e.g. using the Select TV Source prompt 105 of FIG. 8. (It will be appreciated that other types of input signals are possible, hence the prompt of FIG. 8 includes an “Other” option). Selection of a satellite source concludes the tuner input wizard and sends the process 400 to input selector step 412.

If an air (antenna) signal is selected in step 414, the process proceeds through an ATSC tuner activation in step 420, which requires entry (or receipt) of an activation code, in step 422. Many various embodiments of activation have been described herein, and the steps 420 and 422 may include various aspects of these processes. After the activation, an ATSC channel scan may be performed in step 426.

If the user selects a cable source is selected in step 414, then the system inquires whether the user has a set top box (step 430). This may involve a user input in response to a prompt; cf. FIG. 9. If a set top box is present, the user selects from a list of connections in step 440. Typical types of connection include HDMI and Component. If the user selects an RF connection however (coaxial cable), the system displays a warning that an RF connection will provide poor video quality and cable subscribers may wish to contact their cable provider to request an upgrade. The system exits the set top box branch to step 412 (input selector) in order to configure the system for connection of the set top box.

If the user indicates at step 430 that a set top box is not present, then in step 432 QAM tuner activation is initiated, which requires entry (or receipt) of an activation code, in step 434. The prompts and procedures used at steps 432 and 434 can be similar to the procedures for ATSC tuner activation at 420 and 422. Following activation of the QAM tuner the system proceeds with a QAM channel scan in step 426.

In the case of a single-tuner DTV such as that of FIG. 2B, the system goes through the tuner activation process only once. (However, a user can change the type of tuner or other input later during the service life in which case the user may activate the ATSC tuner or QAM tuner for the first time at that stage). In the case of a dual-tuner DTV with initially-deactivated tuners, such as that of FIG. 2A, the set-up procedure would permit separate activation of each tuner. Multi-tuner activation can involve the same type of tuner (e.g. two ATSC tuners) or different types of tuners (e.g. an ATSC tuner and a QAM tuner).

It will further be appreciated that many variations are possible on the embodiments described above. For instance, as observed above, the feature to be selectively activated may be any of a wide variety of features or functionality of a display device, besides a tuner. In addition, it will be appreciated that the “activation” may broadly encompass changing functionality of one or more features. The change in functionality may involve actually removing functionality (de-activation) of an initially-activated feature. Broadly speaking, the change in functionality of a feature from a first state to a second state may involve activation or de-activation, with the change of functionality reported to an activation service.

Although the invention(s) has (have) been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of controlling display device configuration, the method comprising:
providing a display device that includes an initially-deactivated feature;
providing an end user of the display device with an opportunity to activate the initially-deactivated feature; and
if the end user makes a decision to activate the feature, providing notification of the decision to activate to an activation service.

2. The method of claim 1, wherein the providing notification includes providing notification of activation of the initially-deactivated feature.

3. The method of claim 1, wherein the providing notification is part of an activation process that includes the activation service providing an activation code to the end user to allow activation of the deactivated feature.

4. The method of claim 1, wherein the providing notification is part of a notification process that is initiated by the end user interacting with the display device to select a configuration of the display device that requires activation of the initially-deactivated feature.

5. The method of claim 4, wherein the interacting includes the end user affirmatively selecting the configuration in an interactive process with the display device.

6. The method of claim 4, wherein the interacting includes connecting an audio video source to the display device that requires the initially-deactivated feature.

7. The method of claim 1, wherein the providing the display includes providing the display with a tuner as the initially-deactivated feature.

8. The method of claim 7, wherein the tuner includes an Advanced Television Systems Committee (ATSC) standards tuner.

9. The method of claim 1, wherein the providing notification includes providing a registration code to the activation service.

10. The method of claim 9, wherein the providing the registration code includes providing the registration code from the display device directly to the activation service.

11. The method of claim 10, wherein the providing the registration code includes providing the registration code from the display device to the activation service using a telephone connection between the display device and the activation service.

12. The method of claim 10, wherein the providing the registration code includes providing the registration code from the display device to the activation service using a computer network connection between the display device and the activation service.

13. The method of claim 9, wherein the providing the registration code includes the end user communicating the registration code to the activation service.

14. The method of claim 1, wherein the providing notification includes providing the notification from the display device directly to the activation service.

15. The method of claim 1, further comprising receiving an activation code from the activation service.

16. The method of claim 15, wherein the activation code is received at the display device directly from the activation service.

17. The method of claim 15,
wherein the activation code is received by the end user; and
further comprising the end user inputting the activation code into the display device.

18. The method of claim 1, wherein the providing the end user includes providing the end user with the opportunity to activate the initially-deactivated feature in response to a prompt displayed on the display device.

19. The method of claim 18, wherein the prompt queries the end user as to whether the initially-activated feature is to be activated.

20. The method of claim 18, wherein the prompt queries the end user as to a signal source to be used for the display device, with activation occurring for at least some response to the prompt.

21. The method of claim 1, wherein the providing the end user includes providing the end user with the opportunity to activate the initially-deactivated feature by connecting a signal source to the display device.

22. The method of claim 21, wherein activation occurs only for some possible signal sources that may be connected to the display device.

23. A method of paying licensing or other fees for display devices, the method comprising:
providing the display devices to end users, wherein the display devices each have an initially-deactivated feature;
receiving from an activation service information on the number of activation transactions for the display devices; and
paying the fees based on the number of the activation transactions.

24. The method of claim 23, wherein the receiving the number of activation transactions includes receiving from the activation service a number of end users that have notified the activation service of a decision to activate the feature and have received activation instructions from the activation service.

25. The method of claim 23, wherein the receiving the number of activation transactions includes receiving from the activation service a number of display devices that have had the initially-deactivated feature activated.

26. The method of claim 25, wherein the receiving notification includes direct contact between the display devices and the activation service.

27. The method of claim 25, wherein the receiving notification includes direct contact between the end users and the activation service.

28. The method of claim 25, wherein the receiving includes the activation service receiving a registration code from at least one of the end users or the display devices.

29. The method of claim 28, further comprising the activation code sending an activation code to at least one of the end users or the display devices, in response to the receiving the registration code.

30. The method of claim 23, wherein the paying the fees includes paying the fees based also on additional information regarding the display devices.

31. The method of claim 30, further comprising providing the additional information for the display devices.

32. The method of claim 30, wherein the additional information includes screen sizes of the display devices.

33. The method of claim 30, wherein the additional information includes prices of the display devices.

34. The method of claim 33, wherein the prices include net selling prices of the display devices.

35. A method of controlling display device configuration, the method comprising:
providing a display device that includes a feature in a first state;
providing an end user of the display device with an opportunity to change functionality of the feature from a first state to a second state; and
if the end user changes functionality of the feature, providing notification of the change of functionality to an activation service.
